(19) United States
(12) Patent Application Publication
(10) Pub. No.: US 2016/0350882 A1
(43) Pub. Date: Dec. 1, 2016

(54) COMMUNICATING INFORMATION TO DEVICES BASED ON A CHARACTERISTIC OF A SERVICE PROVIDER

(71) Applicant: Uber Technologies, Inc., San Francisco, CA (US)

(72) Inventor: Benjamin Luke Metcalfe, San Francisco, CA (US)

(21) Appl. No.: 15/166,212

(22) Filed: May 26, 2016

Related U.S. Application Data
(60) Provisional application No. 62/167,181, filed on May 27, 2015.

(51) Int. Cl. G06Q 50/10; H04L 12/58

(52) U.S. Cl. CPC G06Q 50/10; H04L 51/24; G06Q 2240/00

(57) ABSTRACT

A system can receive a request for a transport service from a rider device and can determine that a destination location information has not been included in the request. The system can arrange the transport service to be provided by a driver for the rider. The driver can be associated with a profile that includes data indicating that the driver has a particular characteristic. Based on determining that the destination location information has not been included in the request and determining that the driver has the particular characteristic, the system can transmit, to the rider device, a notification requesting the rider to provide a user-specified destination.

### RELATED APPLICATIONS

This application claims the benefit of priority to U.S. Provisional Patent Application No. 62/167,181, filed May 27, 2015, titled COMMUNICATING INFORMATION TO DEVICES BASED ON A CHARACTERISTIC OF A SERVICE PROVIDER; the aforementioned application being incorporated by reference in its entirety.

### BACKGROUND

A network service can enable users to request and receive various services through use of computing devices. However, in some instances, some users may have a difficult time using current network services as a result of their physical disabilities.

### BRIEF DESCRIPTION OF THE DRAWINGS

FIG. 1 illustrates an example system to communicate information in connection with a transport service based on a characteristic of a service provider, under an embodiment.

FIGS. 2A through 2C illustrate example methods of communicating information in connection with a transport service based on a characteristic of a service provider, according to an embodiment.

FIG. 3 illustrates an example diagram that depicts a communication flow, in an embodiment.

FIGS. 4A through 4C illustrate examples user interfaces that are displayed on computing devices, according to one or more embodiments.

FIG. 4D illustrates a driver device that displays an invitation user interface with one or more additional visual features based on the driver's characteristic.

FIG. 5 is a block diagram that illustrates a computer system upon which embodiments described herein may be implemented.

FIG. 6 is a block diagram that illustrates a mobile computing device upon which embodiments described herein may be implemented.

### DETAILED DESCRIPTION

In examples described herein, a network service can provide a mechanism that controls the manner in which communications are provided to users of computing devices. According to examples, the network service can transmit a variety of communications to computing devices operated by both riders and drivers in connection with transport services. In some cases, a communication that is provided in a default mode can include a visual feature and/or an audible sound to capture the attention of a rider or a driver. On occasion, however, when a user of the network service, such as a driver, is deaf or hard of hearing (also referred to herein as deaf), the network service can cause the communication to be provided in a different mode than the default mode in order to tailor the communication for that user.

For example, a computing system that implements the network service can receive, from a rider device, a request for a transport service from a rider and can arrange the transport service to be provided by a driver. The computing system can determine, from the driver's associated profile or account, whether that driver has a particular physical characteristic, e.g., whether the driver has specified in the driver's profile that he or she is deaf or hard of hearing. Based on determining that no destination location information was provided by the rider and determining that the driver has the particular physical characteristic, the computing system can transmit a notification to the rider device requesting the rider to provide a user-specified destination. By informing the rider that the driver is deaf or hard of hearing and/or by receiving the user-specified destination location information, the network system can reduce the amount of friction experienced by both the rider and the driver when the transport service is initially started (e.g., the rider would know in advance not to verbally engage the driver or verbally inform the driver to travel to a particular destination).

In examples in which a network service arranges transport as between rider and driver, the notification or intervention by the network service can provide benefits which include (i) reduction in trip time, as measured by when the rider enters the vehicle, and (ii) more efficient computing device usage by one or both parties, in that one or both users will not waste time or effort to communicate in a manner that is not effective. Moreover, examples as described make transport arrangement services and other on-demand services more available to users who may, as a result of, for example, a physical characteristic have less use or freedom to receive benefits of such services (e.g., to use service as a driver).

In some examples, the computing system can communicate with a designated service application that operates on a computing device, such as a driver application that operates on the driver's computing device (referred to herein as the driver device). The computing system can arrange the transport service by selecting the driver from a set of available drivers and transmitting an invitation message to the driver application. Depending on implementation, if the driver is determined to have the particular characteristic, the computing system and/or the driver application can cause an invitation user interface to be displayed on the driver device with an additional visual feature, as opposed to a default invitation user interface that does not include the additional visual feature. For example, the additional visual feature can be used in place of an audible sound and can correspond to a periodic flashing of a color on the invitation user interface. As an addition or an alternative, the computing system and/or the driver application can periodically cause a flash or a strobe of a camera of the driver device to turn on and turn off during the time the invitation user interface is displayed. The flashing display or light can be used to capture the attention of the driver, especially when an audible tone or sound is impractical for a driver that may be deaf or hard of hearing.

Still further, the computing system and/or the driver application can use data from other resources and/or device components to determine when an additional visual feature is to be outputted on the driver device. For example, the computing system and/or the driver application can determine, for the driver, the current time of day, e.g., based on the driver's current location, and can control which visual feature(s) is to be outputted based on the current time of day. In another example, the driver application can detect or measure an amount of light surrounding the driver device using one or more sensors of the driver device. The driver application can control which visual feature(s) is to be outputted based on the detected amount of light.

Among other benefits, some examples described herein recognize that some service providers that use a network service to provide transport services may be deaf or hard of hearing, and that mechanisms can provide additional assistance for such service providers. Among benefits and technical effects achieved with examples as described, different device resources can be used by the network service to selectively provide additional visual signals for those service providers that may be deaf of hard of hearing.

As used herein, a rider device, a driver device, a computing device, and/or a mobile computing device refer to devices corresponding to desktop computers, cellular devices or smartphones, personal digital assistants (PDAs), laptop computers, tablet devices, etc., that can provide network connectivity and processing resources for communicating with a network service over one or more networks. Rider devices and driver devices can each operate a designated service application (e.g., a client application and a driver application, respectively) that is configured to communicate with the network service (e.g., a server or computing system that implements the network service). A driver device can also correspond to a computing device or custom hardware that is installed in or incorporated with a vehicle, such as part of the vehicle's on-board computing system.

Still further, examples described herein relate to a variety of services, such as a transport service, a food truck service, a delivery service, an entertainment service, a house cleaning service, etc., or generally, any on-demand service or any variable-priced service and/or post-paid transaction between a user and a service provider or provider of goods. Although examples described herein refer to a rider that requests a transport service for purpose of simplicity, in general, a rider can refer to an individual operating a device that makes a request for a location-based service, such as described above. In some examples, the network service can be implemented or operated by an entity that provides goods or services for purchase or arranges for goods or services to be purchased through the use of computing devices and network(s).

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described herein can be carried and/or executed. In particular, the numerous machines shown with examples described herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

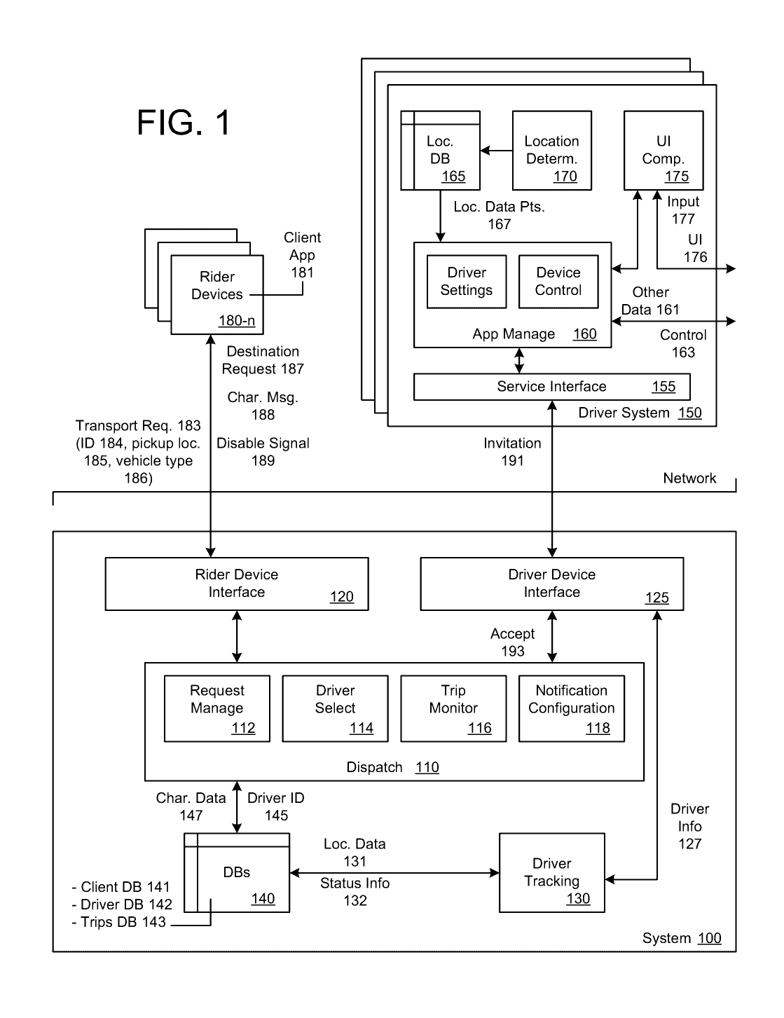

FIG. 1 illustrates an example system to communicate information in connection with a transport service based on a characteristic of a service provider, under an embodiment. According to an example, a service arrangement system 100 (referred to herein as a system that implements the network service) includes a dispatch 110, a rider device interface 120, a driver device interface 125, a driver tracking component 130, and a plurality of databases 140. The plurality of databases 140 can include, for example, a rider database 141, a driver database 142, a trips database 143, and other databases. The rider database 141 can store a plurality of rider profiles or accounts that are associated with riders and/or the rider devices 180 operated by those riders. Similarly, the driver database 142 can store a plurality of driver profiles or accounts that are associated with drivers and/or the driver devices operated by those drivers. The trips database 143 can store trip entries each corresponding to a transport service and can each be associated with a rider and/or a driver.

A plurality of rider devices 180 and a plurality of driver devices (each implementing a driver system 150) (e.g., service provider devices) can communicate with the system 100 over one or more networks using, for example, respective designated service applications that are configured to communicate with the system 100. For example, each rider device 180 can store and run a designated client application 181 that enables communications to be exchanged between that rider device 180 and the system 100. Each driver device can also store a designated driver application, which, depending on implementation, corresponds to, is a part of, or includes the driver system 150. As described herein, the components of the system 100 and/or the components of the driver system 150 can combine to perform operations to mitigate potential delays in communication between the system 100 and the driver system 150. Logic can be implemented with various applications (e.g., software) and/or with hardware of a computer system that implements each of the system 100 and the driver system 150.

Depending on implementation, one or more components of the system 100 can be implemented on network side resources, such as on one or more servers. The system 100 can also be implemented through other computer systems in alternative architectures (e.g., peer-to-peer networks, etc.). As an addition or an alternative, some or all of the components of the system 100 can be implemented on rider or driver devices, such as through applications that operate on the rider devices 180 and/or the driver devices. For example, a driver application can execute to perform one or more of the processes described by the various components of the system 100. The system 100 can communicate over a network, via a network interface (e.g., wirelessly or using a wireline), to communicate with the one or more rider devices 180 and the one or more driver devices.

The system 100 can communicate, over one or more networks, with rider devices 180 and driver devices using a rider device interface 120 and a device interface 125, respectively. The device interfaces 120, 125 can each manage communications between the system 100 and the respective computing devices 180, 190. The rider devices 180 and the driver devices can individually operate client applications 181 and driver applications (or driver systems 150), respectively, that can interface with the device interfaces 120, 125 to communicate with the system 100. According to some examples, these applications can include or use an application programming interface (API), such as an externally facing API, to communicate data with the device interfaces 120, 125. The externally facing API can provide access to the system 100 via secure access channels over the network through any number of methods, such as web-based forms, programmatic access via RESTful APIs, Simple Object Access Protocol (SOAP), remote procedure call (RPC), scripting access, etc.

As described herein, the system 100 can receive a transport request from a rider device 180, process the transport request by selecting a driver to provide the transport service (also referred to herein as a “trip”) for the requesting rider, and invite the selected driver to provide the trip. In the example of FIG. 1, a rider can provide input via the client application 181 to request a transport service. The system 100 can receive a transport request 183 from the rider device 180 of that rider via the rider device interface 120. According to one example, the transport request 183 can include a user identifier (ID) 184, a pickup location data point 185 (or a pickup address), and a vehicle type 186 (e.g., a category or class of vehicles that the rider wants to be transported in). As described herein, a location data point can correspond to a geo-coordinate of a coordinate system, such as a latitude and a longitude point. In one example, the pickup location data point 185 can be determined using the global positioning system (GPS) receiver of the rider device 180. The transport request 183 can also include a destination location data point (or a destination address), if specified by the rider at the time the transport request 183 is made. In some examples, after making the transport request 183, the rider may also operate the client application 181 to input the destination location data point (e.g., while the system 100 is selecting the driver, after the system 100 selects the driver, while the driver is traveling to the pickup location, after the transport service begins, etc.).

The dispatch 110 can process the transport request 183 for the rider. In one example, the request manage component 112 receives the transport request 183 (or some or all of the information from the transport request 183) to authorize the rider (e.g., by checking the rider's credentials and/or payment information in the client database 141) and to determine the user-specified parameters for the transport request 183. In this example, the rider may not have inputted a destination location via the client application 181 when making the transport request 183. The request manage component 112 can indicate that no destination was provided at the time the transport request 183 was received. The request manage component 112 can provide the service location information (e.g., the pickup location data point 185 and/or the destination location data point, if provided by the rider) and the vehicle type 186 to the driver select component 114. The request manage component 112 can also create a trip entry for the requested transport service in the trips database 143 and associate the rider's ID 184 with the trip entry (or an identifier of the trip entry).

The driver select component 114 of the dispatch 110 can select a driver for the rider based on the rider's specified transport parameters. Depending on implementation, the driver select component 114 can use a variety of factors to select a driver (having a vehicle of the requested vehicle type) for the rider, such as selecting the closest driver (based on shortest distance or shortest estimated travel time to the pickup location data point 185) or selecting a driver that will be traveling close to the pickup location data point 185 and/or the destination location data point, if provided by the rider. The driver select component 114 can access the driver database 142, which stores real-time or close to real-time driver information (e.g., such as the drivers' or driver devices' current locations and statuses) of those drivers that are within a specified region or distance of the pickup location data point 185 to perform the driver selection process based on the rider's specified transport parameters.

For example, the driver tracking 130 can periodically receive driver information 127 from driver systems 150 via the driver device interface 125. The driver tracking 130 can store, for each driver that is operating the driver system 150 or driver application, information about that driver's locations (referred to as location data 131) and that driver's statutes (referred to as status info 132) in the driver database 142. Referring to the driver system 150 of a driver device, for example, the driver system 150 can include a location determination 170 that periodically determines the current location of the driver device using the GPS receiver of that driver device and/or a wireless communication device(s) (e.g., Wi-Fi device). The location determination 170 can store, in a location database 165, the location data points 167 corresponding to the current location at individual instances in time.

When the driver system 150 runs on the driver device (e.g., the driver launches the driver app) and the driver goes on duty (e.g., updates the driver's state or application state as being available to receive transport service invitations), the application manage 160 can periodically provide the location data points 167, via the service interface 155, to the system 100 over one or more networks (e.g., using a cellular network). In this manner, the system 100 can store data about where the drivers are and the status of the drivers (e.g., on-duty and available, off-duty, on trip and providing transport, etc.).

Referring back to the system 100, the driver select component 114 can select a driver to provide the transport service for the rider (e.g., identify the driver ID 145 of the driver). According to some examples, the dispatch 110 can include a notification configuration component 118 that determines the manner in which communications are to be provided to riders and/or drivers based on a characteristic of the riders and/or drivers. While the notification configuration component 118 is illustrated in the example of FIG. 1 as being part of the dispatch 110, in other examples, the notification configuration component 118 can be a separate component of the system 100 that communicates with the dispatch 110 and the database 140. The dispatch 110 can determine, based on the driver ID 145 of the selected driver, whether that driver has a particular characteristic 147 specified in the driver's profile. For example, each driver can access a driver portal via a web browser (e.g., a website) or the driver application in order to view and/or modify the driver's profile information or settings. One of the features in the driver's profile can correspond to an accessibility setting for deaf or hard of hearing drivers. A driver that is deaf or hard of hearing, for example, can specify in the accessibility setting that the driver is deaf or hard of hearing.

According to an example, when the driver's profile includes data indicating that the driver has the particular characteristic, e.g., the driver is deaf or hard of hearing, the notification configuration 118 can determine that one or more communications are to be provided to the driver in an alternate or second mode (as compared to a default or first mode). For reference, if a driver that does not have the particular characteristic is selected by the driver select component 114, the notification configuration component 118 can determine that one or more communications or notifications are to be provided to the driver in a default mode. In such a default mode, for example, a communication that is transmitted to that driver's system 150 can be displayed on a user interface along with one or more audible sounds.

For illustrative purposes, in the example of FIG. 1, the selected driver has the particular characteristic specified in the driver's profile. When the driver select component 114 selects the driver to provide the transport service for the rider, the dispatch 110 transmits, via the driver device interface 125, an invitation 191 to the driver's system 150 to enable the driver to accept or reject providing the transport service for the rider. In one implementation, the notification configuration 118 can cause the invitation 191 to include information indicating that the driver has the particular characteristic and/or can configure the invitation 191 to be displayed/outputted in a particular alternate mode as opposed to the default mode. When the application manage 160 receives the invitation 191 for the driver with the particular characteristic, it can cause the user interface (UI) component 175 to output a user interface 176 on the display of the driver device based on data in the invitation 191. In this example, the application manage 160 can determine from the invitation 191 that the invitation user interface 176 is to be provided to the driver in the alternate mode.

As an addition or an alternative, the application manage 160 can receive communications from the system 100 and be preprogrammed to determine how to provide the received communications to the driver based on the driver's characteristic. For example, the driver settings corresponding to that driver can be stored with the driver system 150 (e.g., in the memory resource of the driver device). Alternatively, in another example, after the driver launches the driver application and signs in to the driver system 150, the application manage 160 can retrieve and access the driver settings by communicating with the system 100. The driver settings can include information indicating that the driver has a particular characteristic.

In either implementation, the application manage 160 can control the UI component 175 and/or components of the driver device via the device control component to output the invitation user interface 176 to the driver in the appropriate mode. In one example, for an invitation 191 that is to be provided to the driver in the first or default mode, the application manage 160 can cause the UI component 175 to display the invitation user interface 176 to include information about the transport service to be provided (e.g., the rider's name and/or rating information, the pickup location corresponding to the pickup location data point 185, a map showing the pickup location, etc.). The invitation user interface 176 can include a visual timer that dynamically reduces in size as time elapses, which represents a predetermined duration of time in which the driver can accept the invitation for providing transport (e.g., 15 seconds). In addition, an audible tone or sound can be periodically outputted (e.g., every second or every two seconds that elapses) via the speakers of the driver device in conjunction with the invitation user interface 176. If the predetermined duration of time elapses, the system 100 can determine that the invitation has been rejected by the driver. Alternatively, the driver can select a “reject” feature on the invitation user interface 176 to reject the invitation.

On the other hand, for an invitation 191 that is to be provided to the driver in the second or alternate mode, the application manage 160 can cause the UI component 175 to display the invitation user interface 176 (with information about the transport service to be provided and the visual timer) concurrently with an additional visual feature that is a part of the invitation user interface 176 and/or using another device component of the driver device. In one example, the additional visual feature can correspond to a periodic flashing of a color on the invitation user interface 176 (e.g., a bright color, such as white, yellow, blue, etc., to capture the attention of the driver), such that the screen can light up periodically (e.g., which can periodically obscure the content of the invitation user interface 176). The periodic flashing can be used as opposed to the audible sound that is outputted periodically. The application manage 160 can control the UI component 175 to periodically flash the color during the duration of time that the invitation user interface 176 is displayed.

As an addition or an alternative, the additional visual feature can correspond to a periodic turning on and turning of a flash or a light source of the camera of the driver device (e.g., bright flash blinking). The flash or light source can be a light emitting diode (LED) or another light source or array of light sources that can be illuminated periodically and can be positioned on the front face of the driver device (e.g., as part of a front-facing camera) and/or on the back face of the driver device (e.g., as part of a rear-facing camera). The application manage 160 can provide one or more control signals 163 to control the operation of the flash or light source of the camera via a device interface during the duration of time that the invitation user interface 176 is displayed.

Still further, in another example, the additional feature can be a sensory feature that corresponds to a periodic vibration of the driver device. The driver device can include a vibration mechanism that can cause the driver device to vibrate. The application manage 160 can provide one or more control signals 163 to control the operation of the vibration mechanism and cause the driver device to vibrate periodically during the duration of time that the invitation user interface 176 is displayed.

According to some examples, the dispatch 110 and/or the application manage 160 can control the manner in which the invitation is provided to the driver based on other data, such as the current time of day based on the driver's location or a detected measurement or amount of light surrounding the driver device. The application manage 160 can receive data from other applications that run on the driver device, other network services, and/or from other device components (referred to herein as other data 161). In many instances, drivers may position or mount the driver device on the dashboard of the vehicle so that the display of the driver device faces the driver and the back face of the driver device faces the windshield. During certain times of day, such as when it is dark out, for example, flashing a rear-facing flash or light source of the rear-facing camera may cause a bright reflection on the windshield. This may be dangerous for a driver as the driver's view of the road may be obscured (e.g., periodically) as a result of the reflection.

In some examples, the application manage 160 can determine the current time of day from data from the operating system of the driver device or other applications, such as a clock application, a weather application, etc. Alternatively, the application manage 160 can determine the current location of the driver device and determine the current time of day based on the current location by accessing a network service that provides an accurate time of day based on location data. The application manage 160 can also determine the time of sunrise and the time of sunset for the current location using other data 161 in order to determine if the current time of day is between the time of sunrise and the time of sunset (e.g., if it is light out or dark out). In another example, the application manage 160 can receive sensor data from an ambient light sensor or lightmeter of the driver device, which provides a measurement or an amount of light surrounding the sensor. Based on the measurement or the amount of light being less than a threshold amount (or being greater than or equal to the threshold amount), the application manage 160 can determine if the flash or the light source of the rear-facing camera should be used in conjunction with the invitation user interface 176.

The driver can provide input 177 on the invitation user interface 176 of the driver application to either accept the invitation 191 or reject the invitation 191. Alternatively, the driver can allow the predetermined duration of time to accept the invitation 191 expire). When the input 177 is received to accept the invitation 191, the application manage 160 can provide an acceptance message 193 indicating that the transport service has been accepted to the dispatch 110. The trip monitor component 116 of the dispatch 110 can receive information indicating the driver's acceptance and determine that the transport service has been arranged for the rider.

In addition, once the acceptance message 193 is received, the dispatch 110 can also provide information about the driver and that the transport service has been accepted to the rider device 180. According to an example, the dispatch 110 can transmit different notifications to the rider based on whether the driver has the particular characteristic and/or based on whether the rider has provided the destination location information to the system 100. In the example of FIG. 1, the selected driver has the particular characteristic, e.g., is deaf or hard of hearing, and the rider has not provided a destination location with the transport request 183 and has also not provided the destination location before the transport service was arranged. In such case, the dispatch 110 can transmit a destination request 187 to inform the rider that the driver is deaf or hard of hearing and request the rider to input a destination location (e.g., while the driver is on route to pick up the rider). On the other hand, if, however, the rider has provided a destination location, then the dispatch 110 can transmit a characteristic message 188 to inform the rider that the driver is deaf or hard of hearing. If the driver does not have the particular characteristic, then no additional information is provided to the rider. As an addition or an alternative, the dispatch 110 can transmit a text message or application notification to inform the rider that the driver has been selected, which also includes driver information (e.g., name, rating, vehicle type, vehicle information, etc.).

When the rider provides the destination location, the dispatch 110 can relay the destination location information to the driver system 150. The application manage 160 can use the destination location information to provide a route and/or turn-by-turn directions for the driver once the driver picks up the rider. In this manner, by requesting the destination for the driver and notifying the rider that the driver is deaf or hard of hearing, the network service can reduce the amount of friction and reduce the high probability of a negative situational experience had the rider not known about the driver's characteristic (e.g., the rider would not have to enter the vehicle and start talking to the driver about where to go or how to get there).

Still further, in one example, when the rider is matched with a driver who has the particular characteristic, the dispatch 110 can also transmit a disable signal 189 to the rider device 180 to cause the rider or client application 181 to disable the voice communication functionality used or provided by the client application 181. When the transport service is arranged, the client application 181 can provide a user interface that includes information about the driver and the driver's vehicle. The user interface can also include a selectable feature that, when selected by the rider, causes a default contact interface to be displayed. The rider can be presented with two default contact options (e.g., text the driver, or call the driver). When the rider selects a contact option, a temporary contact number for the driver can be used via the text or phone application of the rider device 180 to communicate with the driver. When the driver has the particular characteristic, however, the disable signal 189 can cause the voice communication mechanism (e.g., the phone application functionality) to be disabled. In such an example, when the rider selects the selectable feature to contact the driver, only one contact option can be provided (e.g., text the driver), and the rider can be prevented from calling the driver.

Once the trip is arranged for the rider, the trip monitor component 116 can monitor the status and progress/performance of the transport service, such as where the driver is relative to the pickup location, by receiving current driver location information 131 from the selected driver system 150 (e.g., periodically). As described herein, the current driver location information 131 can correspond to one or more of the location data points 167 determined by the location determination 170. The dispatch 110 can also provide the progress information to the rider device 180 so that the rider can see the movement and location of the driver.

According to some examples, a rider may also specify in the accessibility setting in the rider's profile or settings, via a rider portal, that the rider is deaf or hard of hearing. In such examples, the selected driver can also be notified of the rider having the particular characteristic, and the rider can also be provided one or more communications from the system 100 in an alternate or second mode. For example, when a notification about the driver approaching the pickup location is provided to the rider in the default or first mode, a notification can be displayed along with an audible tone and/or a vibration of the rider device 180. When the notification is to be provided in the second mode, the notification that the driver is approaching can be displayed along with the flashing (one or more times) of the display screen of the rider device 180 and/or the flashing of a light of the camera of the rider device 180.

Methodology

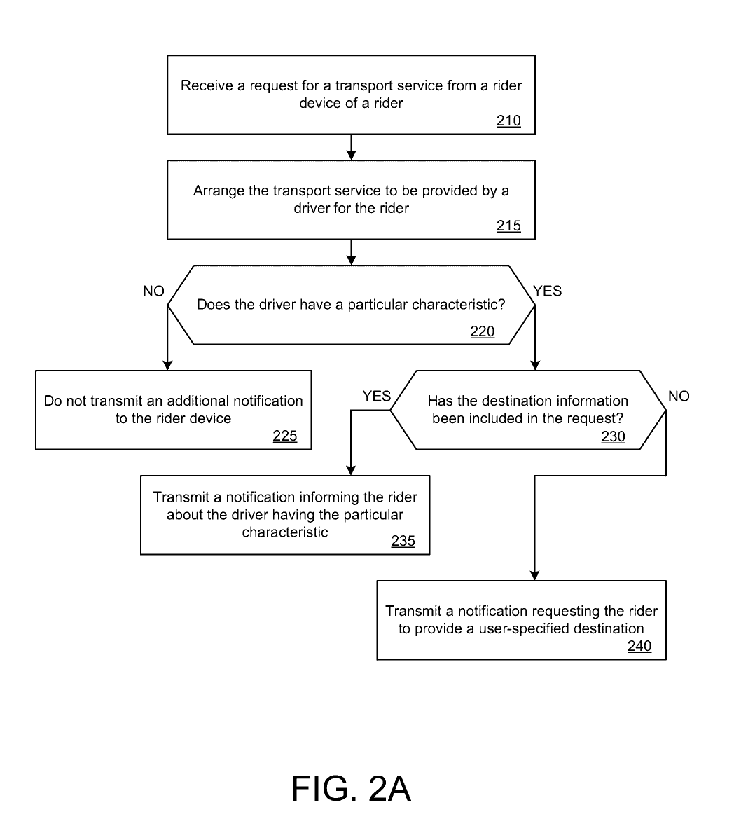

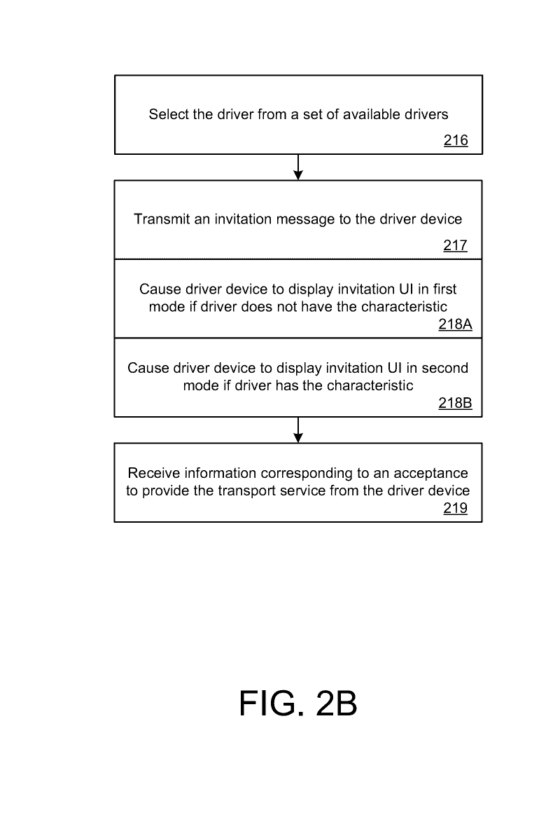

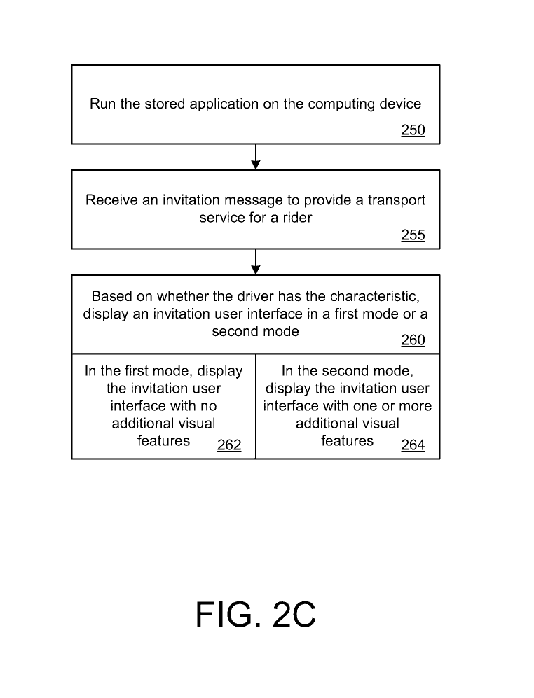

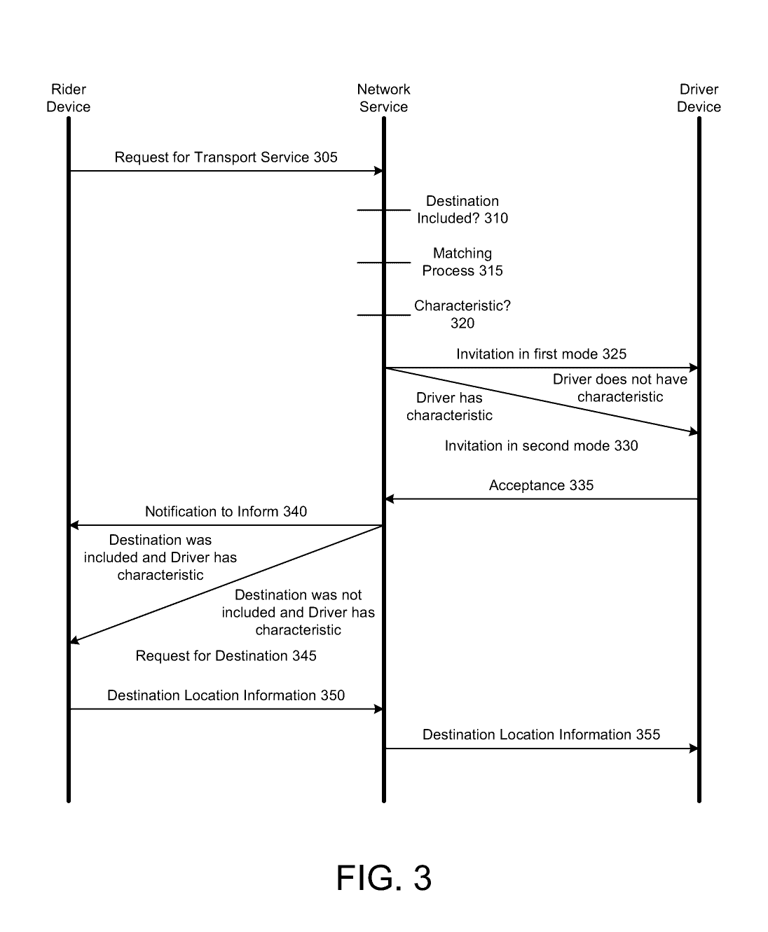

FIGS. 2A through 2C illustrate example methods of communicating information in connection with a transport service based on a characteristic of a service provider, according to an embodiment. FIG. 3 illustrates an example diagram that depicts a communication flow, in an embodiment. The methods such as described by examples of FIGS. 2A through 3 can be implemented using, for example, components described with the example of FIG. 1. Accordingly, references made to elements of FIG. 1 are for purposes of illustrating a suitable element or component for performing a step or sub-step being described.

In one example, FIG. 2A illustrates an operation of the system 100 in order to provide selective information to a rider device. Referring to FIG. 2A, the system 100 can receive a request for a transport service from a rider device of a rider (210). The request can include user-specified information, such as the pickup location, the vehicle type, and the user ID. The request may also include a destination location. In some examples, the destination location can be provided at any time after the transport service is requested until before the transport service is completed.

The system 100 can arrange the transport service to be provided by a driver for the rider (215). As described with the example of FIG. 1, the system 100 can select a driver from a set of candidate drivers that are available or capable of providing the transport service for the rider based on, for example, the pickup location and the current location of each of the candidate drivers. When the transport service is arranged, the system 100 can provide a communication to the rider device to inform the rider that a driver will provide the transport service for the rider and to provide driver information to the rider, such as the driver's estimated travel time away from the pickup location and the driver's name, rating, and/or vehicle type. The system 100 can also determine whether the selected driver has a particular characteristic (e.g., whether the driver is deaf or hard of hearing) (220). The system 100 access the profile of the selected driver and determine whether the profile includes data indicating the particular characteristic. Depending on implementation, the system 100 can make this determination after or when the driver is selected (e.g., during the process of arranging the transport service in step 215).

If the selected driver does not have the particular characteristic, the system 100 does not transmit an additional notification to the rider device (225). On the other hand, if the selected driver has the particular characteristic, the system 100 can determine whether the destination location has been included in the request or has been received at any time (230). If the destination location has been included in the request or received, the system 100 can transmit a notification to the rider device informing the rider that the driver has the particular characteristic (235). On the other hand, if the destination location has not been included in the request or received, the system 100 can transmit a notification to the rider device requesting the rider to provide a user-specified destination (240).

FIG. 2B illustrates an operation of the system 100 in order to provide a communication to the driver device. In one example, the steps of FIG. 2B can be included as part of the step 215 of FIG. 2A. Referring to FIG. 2B, the system 100 can arrange the transport service by selecting the driver from a set of available drivers (216). The system 100 can transmit an invitation message to the driver device of the selected driver (217). Depending on whether the driver has the particular characteristic, the invitation message can be provided to the driver in a first mode or a second mode.

For example, if the driver does not have the particular characteristic, the driver application running on the driver device can use the invitation message to display an invitation user interface in a first or default mode (218A). On the other hand, if the driver has the particular characteristic, the driver application can use the invitation message to display an invitation user interface in a second or alternate mode, such as described in FIG. 1 (218B). Once the driver receives the invitation, the driver can provide an input to accept the invitation or reject the invitation. If the driver accepts the invitation, e.g., by touching the touch-sensitive display of the driver device, the system 100 can receive information corresponding to an acceptance to provide the transport service for the rider (219). The system 100 can determine that the transport service has been arranged for the rider.

FIG. 2C illustrates an operation of the driver device, in one example. In FIG. 2C, a driver can launch and run a stored driver application on the driver device (250). The driver application can be a designated service application that communicates with a remote computing system (e.g., communicates with the network service) over one or more networks. The driver can also log in or sign in using the driver's credentials to enable the remote computing system to authenticate or validate the driver as one who can use the network service to accept and provide transport services for riders.

When the driver is on duty, e.g., has specified on the driver application that he or she is available to provide transport service, the driver application can receive invitations from the remote computing system. In the example of FIG. 2C, the driver device can receive an invitation message to provide a transport service for a rider that requested the transport service (255). The driver application can use the invitation message to provide an invitation user interface to the driver. According to one example, based on whether the driver has a particular characteristic, the driver application can display the invitation user interface in a first mode or a second mode (260). Depending on implementation, the driver application can determine the manner in which to provide the invitation user interface to the driver based on data in the invitation message or based on stored data accessed by the driver application. For example, data can be accessed by the driver application, which can indicate whether the driver has the particular characteristic.

In one example, when the invitation user interface is displayed in the first or default mode, the invitation user interface includes (i) rider information, (ii) pickup location information, (iii) a map, and (iv) a visual timer that dynamically reduces in size as the predetermined duration of time to accept the invitation elapses (e.g., 10 seconds or 15 seconds) (262). As the time elapses, the driver application can also cause an audible tone (e.g., a beep) to be outputted (e.g. periodically) via the speakers of the driver device while the visual timer dynamically reduces in size until the invitation is accepted or rejected. On the other hand, when the invitation user interface is displayed in the second or alternate mode, the invitation user interface can be displayed in a manner similar to the first mode, but can be accompanied by one or more additional visual features (264). The visual feature can be a periodic flashing of a color on the invitation user interface during the predetermined duration of time that the invitation user interface is displayed and/or can be a periodic turning on and turning off of a flash or light of a camera of the driver device during the predetermined duration of time that the invitation user interface is displayed. In some examples, the turning on and turning off of the light source of the camera may be based on other data, such as described in FIG. 1.

FIG. 3 illustrates an example diagram that depicts a communication flow between the system 100 and the rider and driver devices. The rider device transmit a request for transport service (305) to the network service (or remote computing system). The network service processes the request for the rider. It can determine whether the destination has been included in the request or has been received at a time afterwards (310). The network service can initiate the matching process (315) for the rider, e.g., perform a driver selection process for the rider and arrange the transport service. After selecting the driver, the network service can determine whether the selected driver has a particular characteristic (320).

If the driver does not have the characteristic, the network service can transmit an invitation to the driver device, so that an invitation user interface can be provided to the driver in a first mode (325). Depending on implementation, the invitation can include data to control how the driver application is to provide the invitation user interface, or the driver application can be preprogrammed to control how to provide the invitation user interface based on driver characteristic data retrieved from the network service and/or stored in the driver device. If the driver does have the characteristic, the network service can transmit an invitation to the driver device, so that an invitation user interface can be provided to the driver in a second mode (330).

In the example of FIG. 3, the driver has accepted the invitation and the driver device can transmit an acceptance message to the network service (335). In addition, in the example of FIG. 3, the driver is determined to have the particular characteristic. Once the network service receives the acceptance message, the network service can determine that the transport service has been arranged for the rider. The network service can transmit a notification to inform the driver has the particular characteristic if the destination location was provided and the driver has the particular characteristic (340). On the other hand, if the destination location was not provided and the driver has the particular characteristic, the network service can transmit a notification to inform the rider that the driver has the particular characteristic and to request a destination (345). The network service can receive the destination location information from the rider device if the rider inputs the destination (350) and can forward the destination location information to the driver device (355). Still further, the network service can also transmit a disable signal to the rider device to cause the rider application to disable the voice communication functionality for the rider during the duration of the transport service.

User Interface Examples

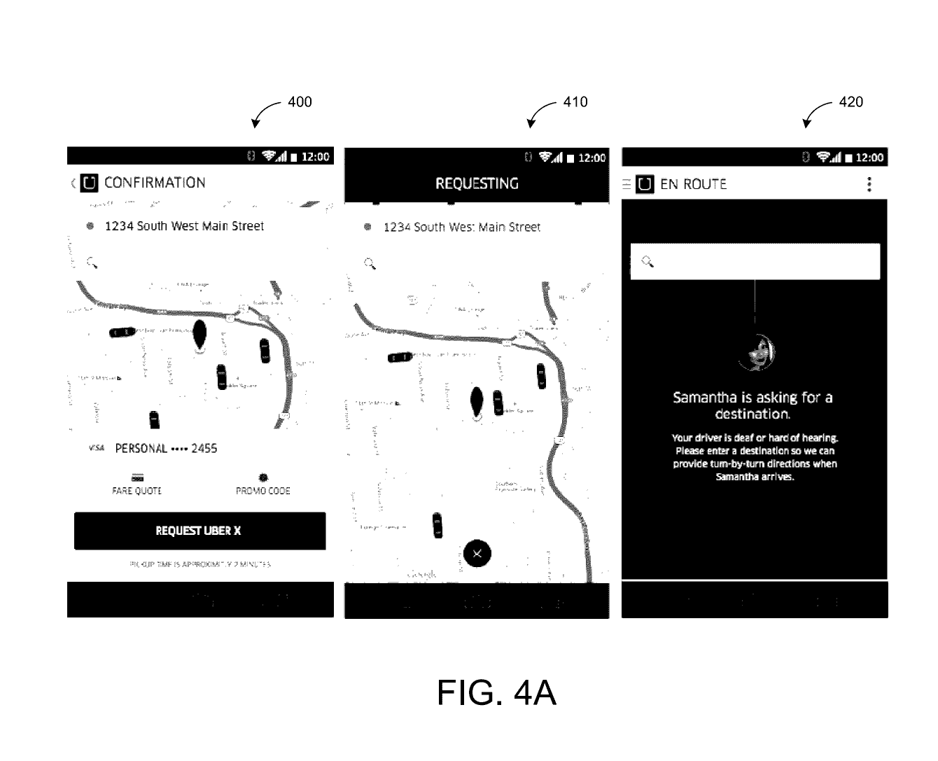

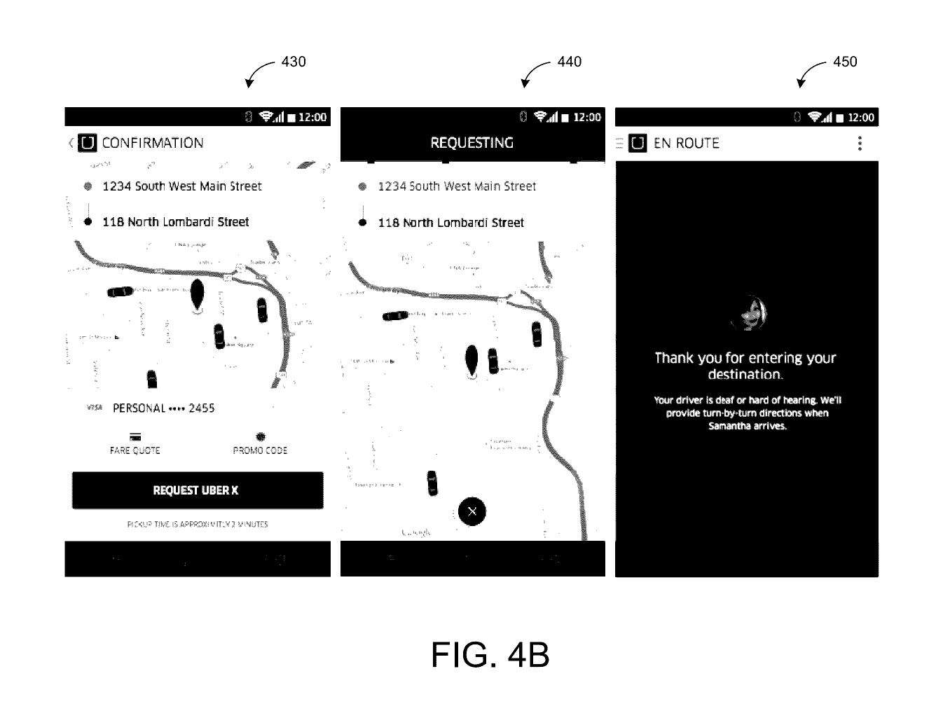

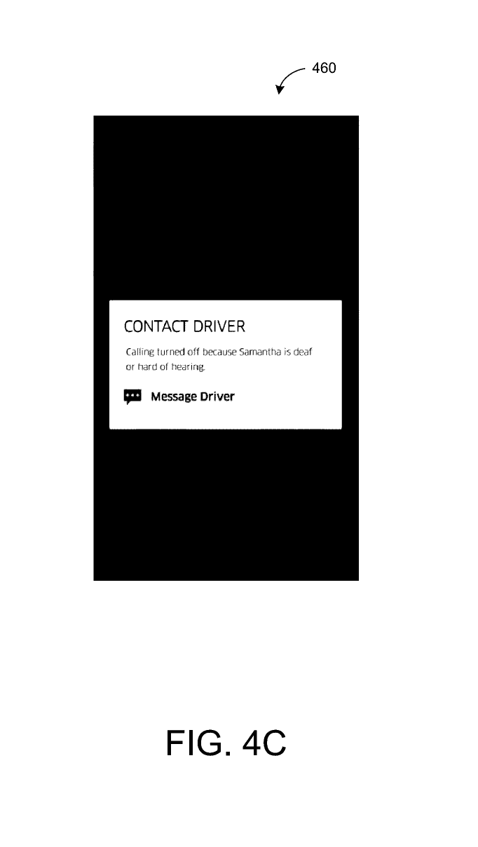

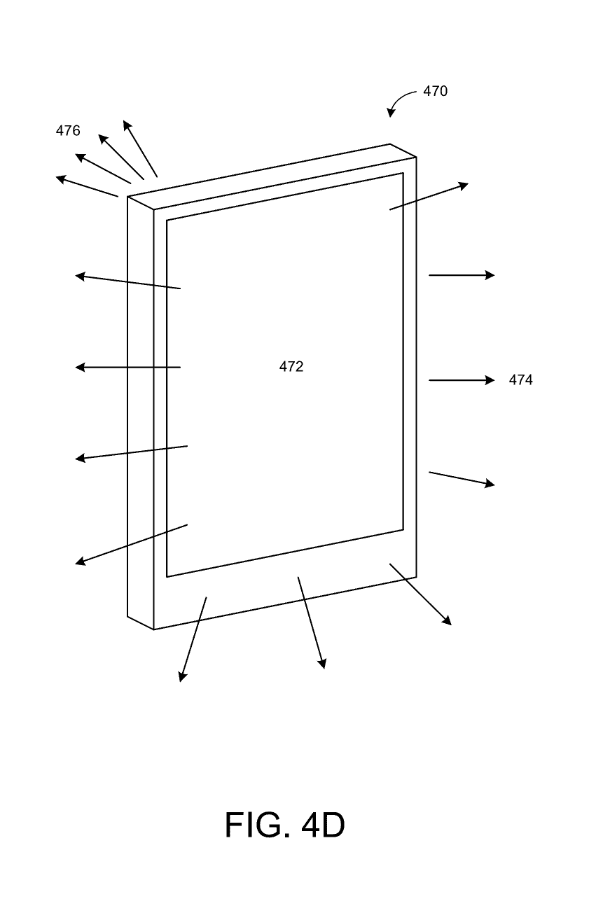

FIGS. 4A through 4C illustrate examples user interfaces that are displayed on computing devices, according to one or more embodiments. FIG. 4A illustrates a sequence of user interfaces that are displayed on the rider device when the network service determines that the driver has a particular characteristic and the destination location has not been provided. In the user interface 400, the rider has provided input on the rider application to make an initial request for transport service. The user interface 400 corresponds to a confirmation screen that shows the pickup location provided by the user or corresponds to the current location of the rider device (e.g., 1234 South West Main Street), the vehicle type (e.g., “Uber X”), and the selected payment profile of the rider. The rider has not provided a destination location in this example. When the rider selects the “Request” feature, the rider application can transmit a request for transport service to the network service.

The rider application can display a requesting user interface 410 to inform the rider that the network service is processing the request for the rider. When a driver is selected, and the driver has a particular characteristic, e.g., is deaf of hard of hearing, the network service can transmit a notification communication to the rider application to request the destination location from the rider. The notification request can be illustrated in the user interface 420. As illustrated in the user interface 420 of FIG. 4A, the notification can include the driver's information (e.g., a photograph and/or a name) and can inform the rider that the driver is deaf or hard of hearing. Such a notification can request the rider to “enter a destination” for the driver. If the rider selects the text box feature “Enter Destination,” the rider application can display another user interface to enable the rider to input a destination (e.g., an address, a landmark, a point of interest, etc.) or select from a list of frequently traveled locations, frequently inputted locations, or favorited locations of the rider (e.g., which can be retrieved from the rider's profile).

FIG. 4B illustrates a sequence of user interfaces that are displayed on the rider device when the network service determines that the driver has a particular characteristic and a destination location has been provided. The user interface 430 is similar to the user interface 400 of FIG. 4A, but the rider in FIG. 4B has provided a pickup location (e.g., 1234 South West Main Street) as well as a destination location (e.g., 118 North Lombardi Street). The rider application can display the requesting user interface 440 after the rider makes the request for transport service. In this example, when a driver is selected, and the driver has the particular characteristic but the destination location has been provided, the network service can transmit a notification communication to the rider application to inform the rider that the driver is deaf or hard of hearing. Because the rider may have provided the destination location before even knowing that the driver is deaf or hard of hearing, the notification user interface 450 can be useful to the rider so that the rider knows how to interact with the driver once he or she gets into the vehicle.

FIG. 4C illustrates a user interface 460 of a rider application that shows a panel for enabling a rider to contact the driver. In the example of FIG. 4C, because the network service determined that the driver has a particular characteristic, the network service has transmitted a disable signal to the rider application to prevent the rider application from accessing voice communication (e.g., phone) functionality of the driver device (e.g., as described in FIG. 1). The disable signal can be transmitted to the rider application any time after the transport service is arranged for the rider. The disable signal can cause the rider application to disable the voice communication functionality from the time the transport service is arranged until the time the transport service is completed. As illustrated in FIG. 4C, the panel can inform the rider that the voice communication functionality has been turned off because the driver is deaf or hard of hearing. The selectable option for communicating with the driver can be limited to messaging the driver using a messaging application.

FIG. 4D illustrates a driver device 470 that displays an invitation user interface with one or more additional visual features based on the driver's characteristic. When the driver operating the driver device 470 has a particular characteristic, the invitation received from the network service causes the driver application to provide the invitation user interface 472 to the driver in an alternate mode (as opposed to a default mode). In the alternate mode, a bright color can flash 474 or blink on the invitation user interface 472, such that the bright color can overlay or replace the invitation user interface 472 for a very short period of time (e.g., for 1 or 2 tenths of a second). For example, a white screen can be quickly displayed for a very short period of time as part of the invitation user interface 472. The bright color can flash 474 periodically until the duration of time to accept the invitation elapses or until user input is provided on the touch-sensitive display screen by the driver. As an addition or an alternative, the driver application can also cause the flash or light of the camera (e.g., the rear-facing camera) to also flash on and off 476, e.g., periodically until the duration of time to accept the invitation elapses or until user input is provided on the touch-sensitive display screen by the driver. In some examples, the camera light is used by the driver application based on certain conditions, e.g., the location of the driver, the time of day, and/or the amount of light present around the driver device.

Hardware Diagrams

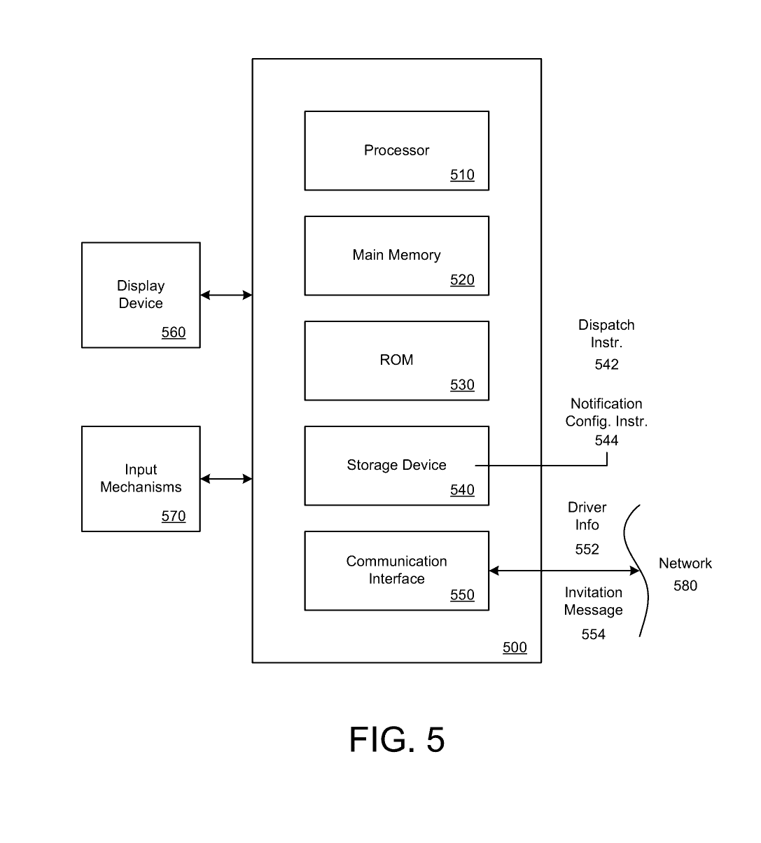

FIG. 5 is a block diagram that illustrates a computer system upon which embodiments described herein may be implemented. For example, in the context of FIG. 1, the system 100 may be implemented using a computer system such as described by FIG. 5. The system 100 may also be implemented using a combination of multiple computer systems as described by FIG. 5.

In one implementation, a computer system 500 includes processing resources 510, a main memory 520, a read only memory (ROM) 530, a storage device 540, and a communication interface 550. The computer system 500 includes at least one processor 510 for processing information and the main memory 520, such as a random access memory (RAM) or other dynamic storage device, for storing information and instructions to be executed by the processor 510. The main memory 520 also may be used for storing temporary variables or other intermediate information during execution of instructions to be executed by the processor 510. The computer system 500 may also include the ROM 530 or other static storage device for storing static information and instructions for the processor 510. A storage device 540, such as a magnetic disk or optical disk, is provided for storing information and instructions, including dispatch instructions 542, notification configuration instructions 544, and other instructions, such as driver tracking instructions. The storage device 540 can also store a plurality of databases and entries, such as described in FIG. 1.

For example, the processor 510 can execute the dispatch instructions 542 to implement logic for processing a request for transport service, determining whether the rider has provided a destination location, selecting a driver to provide the transport service, and determining whether the driver has a particular characteristic, such as described in FIGS. 1 through 4D. The processor 510 can execute the notification configuration instructions 544 to implement logic for causing communications to be outputted to the rider device and/or the driver device using specific notification mechanisms based on whether the driver has a particular characteristic, such as described in FIGS. 1 through 4D.

The communication interface 550 can enable the computer system 500 to communicate with one or more networks 580 (e.g., cellular network) through use of the network link (wireless or wireline). Using the network link, the computer system 500 can communicate with one or more other computing devices, such as rider devices and driver devices, and/or one or more other servers or datacenters. In some variations, the computer system 500 can receive driver information 552 from driver devices via the network link. The computer system 500 can use the driver information 552 to determine, for example, which driver to select to provide a transport service for a requesting rider. When a driver is selected, the computing system 500 can transmit an invitation message 554 to the driver device, such as described in FIGS. 1 through 4D.

The computer system 500 can also include a display device 560, such as a cathode ray tube (CRT), an LCD monitor, or a television set, for example, for displaying graphics and information to a user. One or more input mechanisms 570, such as a keyboard that includes alphanumeric keys and other keys, can be coupled to the computer system 500 for communicating information and command selections to the processor 510. Other non-limiting, illustrative examples of input mechanisms 570 include a mouse, a trackball, touch-sensitive screen, or cursor direction keys for communicating direction information and command selections to the processor 510 and for controlling cursor movement on the display 560.

Examples described herein are related to the use of the computer system 500 for implementing the techniques described herein. According to one embodiment, those techniques are performed by the computer system 500 in response to the processor 510 executing one or more sequences of one or more instructions contained in the main memory 520. Such instructions may be read into the main memory 520 from another machine-readable medium, such as the storage device 540. Execution of the sequences of instructions contained in the main memory 520 causes the processor 510 to perform the process steps described herein. In alternative implementations, hard-wired circuitry may be used in place of or in combination with software instructions to implement examples described herein. Thus, the examples described are not limited to any specific combination of hardware circuitry and software.

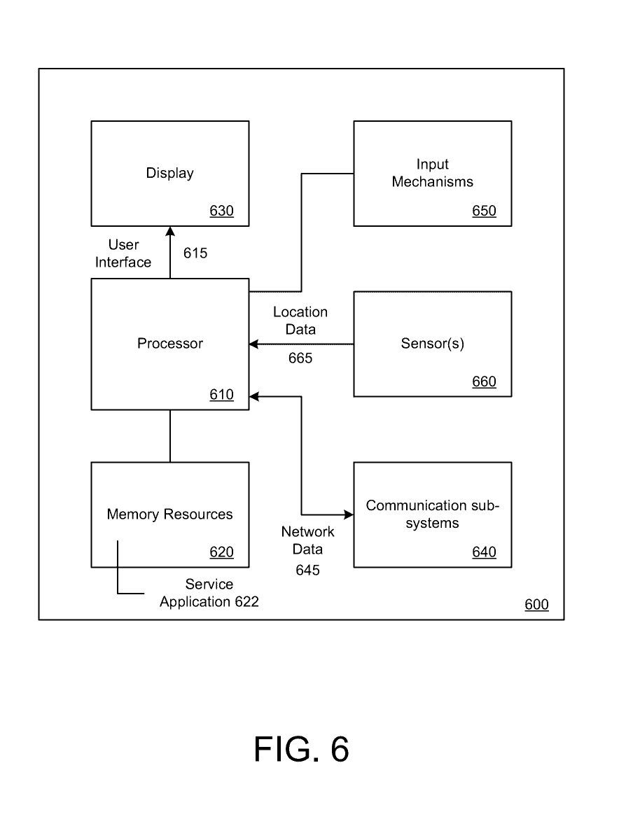

FIG. 6 is a block diagram that illustrates a mobile computing device upon which embodiments described herein may be implemented. In one embodiment, a computing device 600 may correspond to a mobile computing device, such as a cellular device that is capable of telephony, messaging, and data services. The computing device 600 can correspond to a rider device or a driver device. Examples of such devices include smartphones, handsets or tablet devices for cellular carriers. The computing device 600 includes a processor 610, memory resources 620, a display device 630 (e.g., such as a touch-sensitive display device), one or more communication sub-systems 640 (including wireless communication sub-systems), input mechanisms 650 (e.g., an input mechanism can include or be part of the touch-sensitive display device), one or more sensors 660, including a location detection mechanisms (e.g., GPS receiver), and a camera (not shown in FIG. 6). In one example, at least one of the communication sub-systems 640 sends and receives cellular data over data channels and voice channels.

The processor 610 can provide a variety of content to the display 630 by executing instructions and/or applications that are stored in the memory resources 620. For example, the processor 610 is configured with software and/or other logic to perform one or more processes, steps, and other functions described with implementations, such as described by FIGS. 1 through 5, and elsewhere in the application. In one example, the processor 610 can execute instructions and data stored in the memory resources 620 in order to operate a service application 622, as described in FIGS. 1 through 5. Depending on implementation, the service application 622 can correspond to a client application or a driver application. Still further, the processor 610 can cause one or more user interfaces 615 to be displayed on the display 630, such as one or more user interfaces provided by the driver application. Input can be provided on the driver application through a combination of the input mechanisms 650 and the display 630, for example, such as through use of a touch-sensitive display device.

In the example in which the computing device corresponds to a driver device, a driver can operate the computing device 600 to receive invitations for transport services from the network service. The driver application can also communicate with the sensor(s) to determine location data 665 corresponding to the current location of the computing device 600. For example, the computing device 600 can periodically determine a location data point 665 of the current location and provide the location data point 665 to the service arrangement system (not shown in FIG. 6). The service arrangement system can provide communications to the computing system 600 via the communication sub-systems 640, such as network data 645 (e.g., an invitation message). In one example, based on whether the driver has a particular characteristic, the driver service application can provide the invitation user interface based on the network data 645 in a default mode or in an alternative mode, e.g., as described in FIGS. 1 through 5. While FIG. 6 is illustrated for a mobile computing device, one or more examples may be implemented on other types of devices, including full-functional computers, such as laptops and desktops (e.g., PC).

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is being claimed is:

1. A method of communicating information in connection with a transport service, the method being performed by a computing system and comprising:
receiving, from a rider device of a rider, a request for a transport service, the request including a pickup location information;
determining, by the computing system, that a destination location information has not been included in the request received from the rider device;
arranging, by the computing system, the transport service to be provided by a driver for the rider, the driver being associated with a driver profile stored in a data store accessible by the computing system, the driver profile including data indicating that the driver has a particular characteristic; and
based on determining that the destination location information has not been included in the request and determining that the driver has the particular characteristic, transmitting, to the rider device, a notification requesting the rider to provide a user-specified destination.

2. The method of claim 1, wherein arranging the transport service includes:
selecting the driver from a set of available drivers;
transmitting, to a driver device of the driver, an invitation message, the invitation message causing a driver application operating on the driver device to display an invitation user interface; and
receiving, from the driver device, information corresponding to an acceptance to provide the transport service.

3. The method of claim 2, wherein the invitation message includes information indicating that the driver has the particular characteristic, and wherein the invitation message causes the driver application to display the invitation user interface with a visual feature as opposed to a default invitation user interface that does not include the visual feature.

4. The method of claim 3, wherein the invitation user interface is displayed for a predetermined duration of time, and wherein the visual feature corresponds to a periodic flashing of a color on the invitation user interface during the predetermined duration of time that the invitation user interface is displayed.

5. The method of claim 2, wherein the driver application accesses information indicating that the driver has the particular characteristic, and wherein the invitation message causes the driver application to display the invitation user interface with a visual feature as opposed to a default invitation user interface that does not include the visual feature.

6. The method of claim 2, wherein the invitation message includes information indicating that the driver has the particular characteristic, wherein the invitation user interface is displayed for a predetermined duration of time, and wherein the invitation message causes the driver device to periodically turn on and turn off a flash of a camera of the driver device during the predetermined duration of time that the invitation user interface is displayed.

7. The method of claim 2, wherein the driver application accesses information indicating that the driver has the particular characteristic, and wherein the invitation message causes the driver device to periodically turn on and turn off a flash or a light source of a camera of the driver device during the predetermined duration of time that the invitation user interface is displayed.

8. The method of claim 1, further comprising:
based on determining that the driver has the particular characteristic, causing a rider application operating on the rider device to disable a voice communication functionality of the rider application until the transport service is completed.

9. A method of communicating information in connection with a transport service, the method being performed by a computing device and comprising:
running, on the computing device, a driver application that is stored in a memory resource of the computing device, wherein the driver application communicates with a network service over one or more networks;
receiving, from the network service, an invitation message for a driver operating the computing device to provide a transport service for a rider; and
in response to receiving the invitation message, (i) displaying, on the display of the computing device, an invitation user interface of the driver application based on data included in the invitation message, and (ii) concurrently while the invitation user interface is displayed, causing the computing device to output an additional visual feature based on data indicating that the driver has a particular characteristic.

10. The method of claim 9, wherein the invitation user interface is displayed for a predetermined duration of time or until the driver application receives an input from the driver.

11. The method of claim 9, further comprising:
determining a current location using a global positioning system (GPS) receiver of the computing device; and
determining a current time of day based on the current location;
wherein causing the computing device to output the additional visual feature is based on the current time of day.

12. The method of claim 11, wherein when the current time of day corresponds to an instance in time before a sunrise time at the current location or after a sunset time at the current location, the additional visual feature corresponds to a periodic flashing of a color on the invitation user interface.

13. The method of claim 11, wherein when the current time of day corresponds to an instance in time between a sunrise time at the current location and a sunset time at the current location, the additional visual feature corresponds to a periodic turning on and turning off of a flash or a light source of a camera of the computing device.

14. The method of claim 9, further comprising:
detecting an amount of light using an ambient light sensor of the computing device; and
wherein causing the computing device to output the additional visual feature is based on the detected amount of light.

15. The method of claim 14, wherein when the detected amount of light is less than a threshold amount, the additional visual feature corresponds to a periodic flashing of a color on the invitation user interface.

16. The method of claim 14, wherein when the detected amount of light is greater than or equal to a threshold amount, the additional visual feature corresponds to a periodic turning on and turning off of a flash or a light source of a camera of the computing device.

16. A non-transitory computer-readable medium storing instructions that, when executed by one or more processors of a computing system, cause the computing system to:
receive, from a rider device of a rider, a request for a transport service, the request including a pickup location information;
determine that a destination location information has not been included in the request received from the rider device;
arrange the transport service to be provided by a driver for the rider, the driver being associated with a driver profile stored in a data store accessible by the computing system, the driver profile including data indicating that the driver has a particular characteristic; and
based on determining that the destination location information has not been included in the request and determining that the driver has the particular characteristic, transmit, to the rider device, a notification requesting the rider to provide a user-specified destination.

17. The non-transitory computer-readable medium of claim 16, wherein the instructions cause the computing system to arrange the transport service by:
selecting the driver from a set of available drivers;
transmitting, to a driver device of the driver, an invitation message, the invitation message causing a driver application operating on the driver device to display an invitation user interface; and
receiving, from the driver device, information corresponding to an acceptance to provide the transport service.

18. The non-transitory computer-readable medium of claim 17, wherein the invitation message includes information indicating that the driver has the particular characteristic, and wherein the invitation message causes the driver application to display the invitation user interface with a visual feature as opposed to a default invitation user interface that does not include the visual feature.

19. The non-transitory computer-readable medium of claim 18, wherein the invitation user interface is displayed for a predetermined duration of time, and wherein the visual feature corresponds to (i) a periodic flashing of a color on the invitation user interface during the predetermined duration of time that the invitation user interface is displayed, or (ii) a periodic turning on and turning off of a flash or a light source of a camera of the driver device during the predetermined duration of time that the invitation user interface is displayed.

20. The non-transitory computer-readable medium of claim 18, wherein the instructions further cause the computing system to:
based on determining that the driver has the particular characteristic, cause a rider application operating on the rider device to disable a voice communication functionality of the rider application until the transport service is completed.
